(19) United States
(12) Patent Application Publication
(10) Pub. No.: US 2017/0040100 A1
(43) Pub. Date: Feb. 9, 2017

(54) CORE PIECE AND REACTOR

(71) Applicants: AutoNetworks Technologies, Ltd., Yokkaichi (JP); Sumitomo Wiring Systems, Ltd., Yokkaichi, Mie (JP); Sumitomo Electric Industries, Ltd., Osaka (JP)

(72) Inventors: Tatsuo Hirabayashi, Yokkaichi, Mie (JP); Kouji Nishi, Yokkaichi, Mie (JP); Susumu Fukuyama, Yokkaichi, Mie (JP)

(73) Assignees: AutoNetworks Technologies, Ltd., Yokkaichi (JP); Sumitomo Electric Industries, Ltd., Osaka (JP); Sumitomo Wiring Systems, Ltd., Yokkaichi, Mie (JP); Sumitomo Electric Industries, Ltd., Osaka (JP)

(21) Appl. No.: 15/304,353

(22) PCT Filed: Apr. 14, 2015
(86) PCT No.: PCT/JP2015/061452

§ 371 Date: Oct. 14, 2016

(30) Foreign Application Priority Data
Apr. 25, 2014 (JP) 2014-092149

(51) Int. Cl. H01F 27/255; H01F 27/34; H01F 27/28

(52) U.S. Cl. CPC H01F 27/255; H01F 27/2823; H01F 27/34; H01F 2027/348

(57) ABSTRACT

The present invention provides a core piece and a reactor that have excellent bondability to a resin portion and are capable of reducing the generation of eddy currents. The core piece is a core piece that constitutes a magnetic core disposed within or outside a coil formed of a wound wire, the core piece including an end surface that is orthogonal to a magnetic flux flowing through the coil and to which a resin portion is bonded, wherein the end surface has an intersecting groove in which a plurality of grooves intersect without forming a loop. The core piece may be, for example, a powder compact made of metal particles and an insulating material present between the metal particles. The core piece may constitute, for example, a portion of the magnetic core, the portion being disposed within the coil.

### CROSS-REFERENCE TO RELATED APPLICATIONS

This application is the U.S. national stage of PCT/JP2015/061452 filed Apr. 14, 2015, which claims priority of Japanese Patent Application No. JP 2014-092149 filed Apr. 25, 2014.

### FIELD OF THE INVENTION

The present invention relates to a core piece for constituting a magnetic core included in a magnetic component such as a reactor, and a reactor for use as, for example, a component of an on-board DC-DC converter mounted on a vehicle such as a hybrid vehicle or a component of a power conversion apparatus. The present invention particularly relates to a core piece and a reactor that have excellent bondability to a resin portion and are capable of reducing the generation of eddy currents.

### BACKGROUND

A reactor is used as a component of a circuit for performing an operation of increasing voltage and an operation of decreasing voltage. JP 2012-119454A discloses a reactor for use in a converter mounted on a vehicle such as a hybrid vehicle, the reactor including a coil formed of a wire being spirally wound and an annular magnetic core formed of a combination of a plurality of core pieces. JP 2012-119454A also discloses that, in the magnetic core, a core piece disposed within the coil is covered by an insulating coating layer (resin layer), and the resin layer covering an end surface of the core piece functions as a gap.

There is a demand for a core piece and a reactor that have excellent bondability to a resin portion and are capable of reducing the generation of eddy currents.

A coil included in a magnetic component such as a reactor generates heat according to Joule's law when it is energized and does not generate heat when it is not energized. In particular, when a coil is energized by a current having a large current value such as in the case of a reactor for use in an on-board converter, the coil generates a large amount of heat. Accordingly, a core piece disposed near the coil and a resin layer covering the core piece undergo thermal expansion and contraction due to thermal cycling caused by the coil. Since the core piece made mainly of a metal such as iron and the resin have different thermal expansion coefficients, the resin layer may be separated from the core piece. As a result of the resin layer being separated, the resin layer may not be able to perform its function sufficiently.

To address this, the present inventors attempted, in order to increase the bondability between the core piece and the resin portion, to provide the bonding surface of the core piece to the resin portion with irregularities, or to be specific, to form grooves in the bonding surface. As a result, they found that although the bondability between the core piece and the resin portion can be increased depending on the groove shape, upon energization of the groove portions, the generation of eddy currents is facilitated.

The present invention has been made in view of the circumstances described above, and it is an object of the present invention to provide a core piece that has excellent bondability to a resin portion and is also capable of reducing the generation of eddy currents. Another object of the present invention is to provide a reactor that has excellent bondability to a resin portion and is also capable of reducing the generation of eddy currents.

### SUMMARY OF INVENTION

A core piece according to one aspect of the present invention is a core piece that constitutes a magnetic core disposed within or outside a coil formed of a wound wire, the core piece including an end surface that is orthogonal to a magnetic flux flowing through the coil and to which a resin portion is bonded, wherein the end surface has an intersecting groove in which a plurality of grooves intersect without forming a loop.

A reactor according to one aspect of the present invention includes: a coil formed of a wound wire; a magnetic core including a plurality of core pieces comprising the core piece according to one aspect of the present invention; and a resin portion that is bonded to the end surface of the core piece having the intersecting groove.

The above-described core piece has excellent bondability to the resin portion, and is also capable of reducing the generation of eddy currents. The reactor described above has excellent bondability to the resin portion, and is also capable of reducing the generation of eddy currents.

### BRIEF DESCRIPTION OF DRAWINGS

FIG. 1 is a schematic perspective view of a core piece according to Embodiment 1 and a reactor including the core piece.

FIG. 2 is an exploded perspective view of the core piece according to Embodiment 1 and the reactor including the core piece.

FIG. 3 is an explanatory view showing an example of (*-shaped) intersecting grooves formed in an end surface of the core piece according to Embodiment 1.

FIG. 4 is an explanatory view showing an example of (parallel) intersecting grooves formed in an end surface of the core piece according to Embodiment 1.

FIG. 5 is an explanatory view showing an example of (spiral) intersecting grooves formed in an end surface of the core piece according to Embodiment 1.

FIG. 6 is an explanatory view showing an example of (∩-shaped) intersecting grooves formed in an end surface of the core piece according to Embodiment 1.

### DETAILED DESCRIPTION OF THE PREFERRED EMBODIMENTS

An embodiment of the present invention will be first presented and described.

(1) A core piece according to one aspect of the present invention is a core piece that constitutes a magnetic core disposed within or outside a coil formed of a wound wire, the core piece including an end surface that is orthogonal to a magnetic flux flowing through the coil and to which a resin portion is bonded, wherein the end surface has an intersecting groove in which a plurality of grooves intersect without forming a loop.

The intersecting groove refers to a groove in which a part of one groove (hereinafter, referred to as “second groove”) is overlaid on one continuous groove (hereinafter referred to as “first groove”) and intersects with the first groove such that two opposing ends of the second groove protrude through the first groove. The number of grooves that intersect with the first groove in one intersecting groove (two or more), the shape of each groove (which may be linear or curved) and the dimensions of each groove can be selected as appropriate.

The above-described core piece has excellent bondability as a result of the bonding strength with respect to the resin portion bonded to the end surface of the core piece being increased for the reasons given below.

Since a plurality of grooves are formed in the end surface of the above-described core piece to which the resin portion is bonded, the contact area between the core piece and the resin is increased as compared with the case where a plurality of grooves are not formed (JP 2012-119454A or the like). Even if a plurality of grooves are formed, when the grooves are not intersecting grooves such as, for example, when the grooves are linear grooves disposed in parallel, the resin portion bonded to the core piece may be separated in the direction of formation of the grooves. That is, the grooves that are not intersecting grooves have poor bondability in a specific direction. On the other hand, the intersecting groove includes grooves having different directions of formation, and thus the separation of the resin portion in the direction of formation of one groove can be prevented by another groove. Accordingly, by providing the specific intersecting groove, the bonding strength in a given direction between the above-described core piece and the resin portion bonded to the end of the core piece can be effectively increased.

In addition, when the above-described core piece is used in a magnetic component such as a reactor, the generation of eddy currents can be reduced for the reasons given below.

For example, in the case of a groove having intersecting portions such as a grid groove, it is expected that the separation of the resin portion as described above can be prevented. However, with the grid groove, a rectangular frame surrounded by four grooves forms a loop. When a groove having such a loop is formed in one surface of the core piece, the surface being disposed orthogonal to a magnetic flux flowing through the coil, eddy currents are likely to be generated along the loop. Here, if a powder compact in which an insulating material is present between metal particles is used as the core piece, the metal particles are insulated, and thus the eddy current can be reduced. However, even when such a powder compact is used, the insulating material may be removed at the time when grooves are formed, which may cause the metal particles to be electrically connected to each other. That is, with the groove having a loop, electricity is conducted along the loop, and eddy currents according to the loop may be generated. In the above-described core piece, because the specific intersecting groove that does not have a loop is formed in the end surface orthogonal to a magnetic flux flowing through the coil, when it is used in a magnetic component such as a reactor, it is possible to reduce the eddy current caused by the groove and contribute to providing a low-loss magnetic component.

(2) As an example of the above-described core piece, a configuration is possible in which the core piece is a powder compact made of metal particles and an insulating material present between the metal particles.

According to the configuration described above, because the metal particles are insulated by the insulating material, when the core piece is used in a magnetic component such as a reactor, it is possible to reduce the eddy current. In addition, although the insulating material of the groove portion may be removed at the time when the groove is formed, because the groove is a specific intersecting groove that does not have a loop, the eddy current caused by the groove portion (electrical connection portion) can be reduced.

(3) As an example of the above-described core piece, a configuration is possible in which the core piece constitutes a portion of the magnetic core, the portion being disposed within the coil.

According to the configuration described above, although the core piece has a groove in its end surface, because the groove is a specific intersecting groove as described above, when the core piece is used in a magnetic component such as a reactor, it is possible to reduce the eddy current caused by the groove. Also, according to the configuration described above, the resin portion bonded to the end surface in which the specific intersecting groove is formed can be used as a gap. Here, in the case of a magnetic core including a plurality of core pieces and a gap, it is often the case that the gap is provided between the core pieces constituting a portion of the magnetic core, the portion being disposed within the coil. For this reason, a core piece of the above-described configuration is disposed within the coil, a gap member can be omitted. Also, the resin portion bonded to the end surface is strongly bonded to the specific intersecting groove, for example, variations in gap length caused by separation of the resin portion can be prevented. Furthermore, in the case where the resin portion bonded to the end surface also functions as a bonding material for bonding adjacent core pieces, the unitarity of the plurality of core pieces can be enhanced, and it is expected that vibrations and noise will be readily reduced when used in, for example, a reactor. Accordingly, it is expected that the configuration described above have the following effects: (1) contributing to improvement of manufacturability of, for example, a reactor by reducing the number of components of the reactor; (2) contributing to stability of gap length in, for example, a reactor; and (3) contributing to reduction of vibrations and noise of, for example, a reactor.

(4) A reactor according to one aspect of the present invention includes: a coil formed of a wound wire; a magnetic core including a plurality of core pieces including the core piece according to any one of the configurations (1) to (3) described above; and a resin portion that is bonded to the end surface of the core piece having the intersecting groove. In other words, the reactor includes a coil formed of a wound wire, a magnetic core including a plurality of core pieces, and a resin portion bonded to an end surface of at least one of the plurality of core pieces, the end surface being orthogonal to a magnetic flux flowing through the coil, and the end surface including an intersecting groove in which a plurality of grooves intersect without forming a loop.

The above-described reactor includes, as a constituent element, a core piece including the above-described specific intersecting groove formed in an end surface of the core piece to which the resin portion is bonded, and thus the bonding strength between the core piece and the resin portion bonded to the end surface is high, and excellent bondability between the core piece and the resin portion is attained. In addition, in the above-described reactor, the groove formed in the end surface of the core piece, the end surface being orthogonal to a magnetic flux flowing through the coil, is the above-described specific intersecting groove that does not have a loop, and it is therefore possible to reduce the eddy current caused by the groove, and achieve low loss.

(5) As an example of the above-described reactor, a configuration is possible in which the resin portion bonded to the end surface is disposed between core pieces that are adjacent to each other, forming a gap.

The resin portion provided between adjacent core pieces serves as a gap. For this reason, according to the configuration described above, the gap member can be omitted, and thus the number of components can be reduced, and excellent manufacturability can be attained. Also, the resin portion is strongly bonded to the core pieces by the above-described specific intersecting groove, and it is therefore possible to prevent, for example, variations in gap length caused by separation of the resin portion. Furthermore, when the resin portion bonds adjacent core pieces, the unitarity of the plurality of core pieces can be enhanced, and it is expected that vibrations and noise will be readily reduced.

(6) As an example of the above-described reactor, a configuration is possible in which the reactor includes a resin mold portion that covers an outer circumference of at least one of the plurality of core pieces, and the resin portion bonded to the end surface is a part of the resin mold portion.

According to the configuration described above, the bonding strength between the resin mold portion and the core piece including the above-described specific intersecting groove is increased, and thus the resin mold portion is strongly bonded. According to the configuration described above, with the resin mold portion, it is possible to mechanically protect the core piece, as well as protecting the core piece from the environment. Also, in the case where the coated core piece including the resin mold portion is disposed within the coil, the insulation between the coil and the magnetic core can be increased. In addition, the resin portion bonded to the end surface of the core piece can be formed at the same time when the resin mold portion is formed and can be readily formed, and thus the above-described configuration enables the number of manufacturing steps to be reduced and excellent productivity to be achieved.

### DETAILED DESCRIPTION OF THE EMBODIMENT

Hereinafter, a core piece and a reactor according to an embodiment of the present invention will be described in detail with reference to the drawings. Like reference numerals used in the diagrams indicate like components.

### Embodiment 1

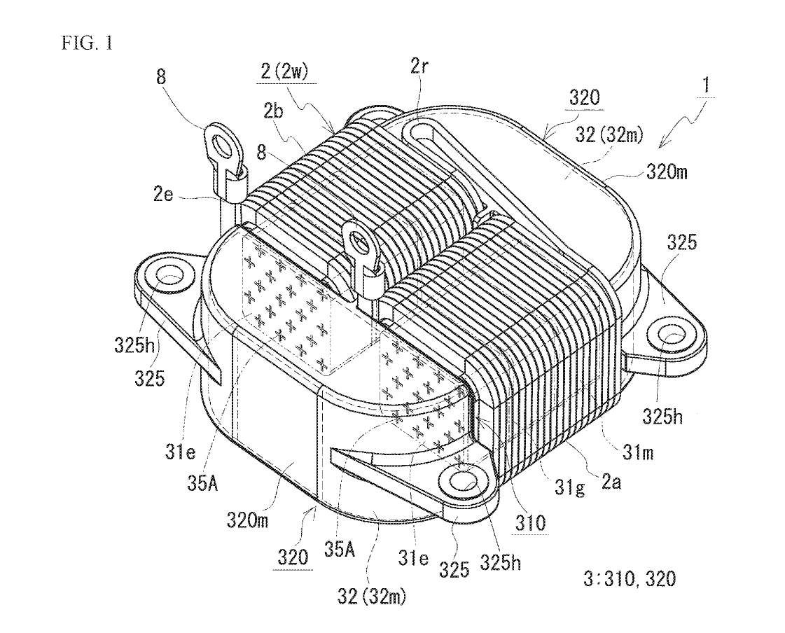

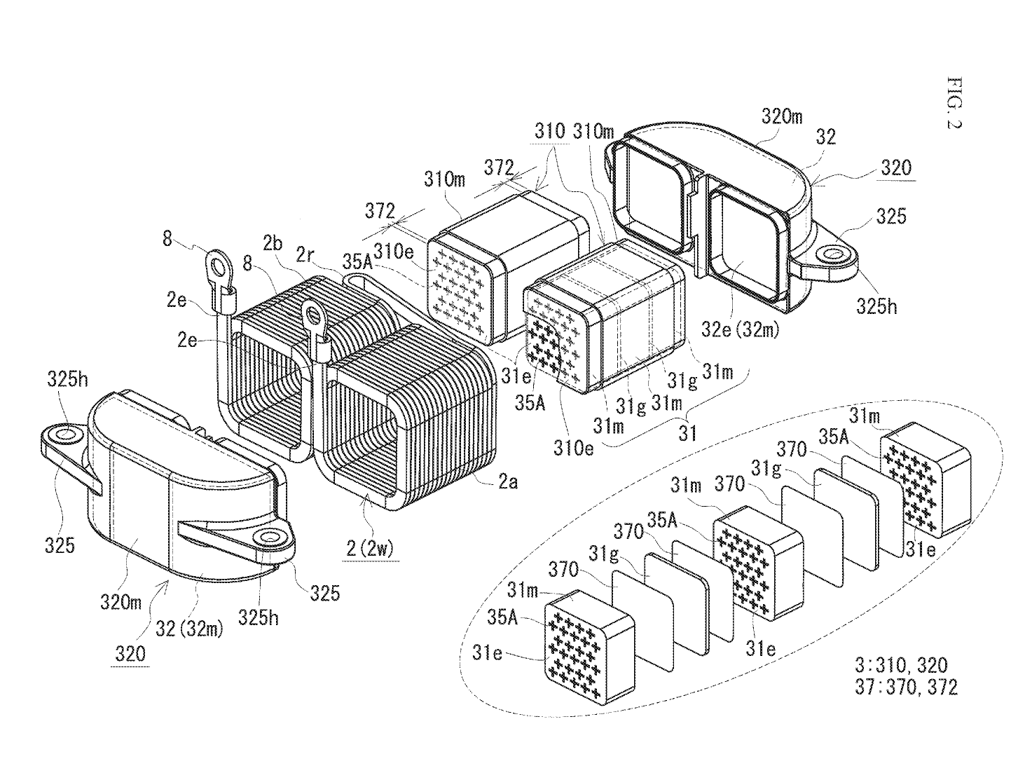

A core piece 31m according to Embodiment 1 and a reactor 1 including the core piece 31m will be described with reference to FIGS. 1 to 6. Intersecting grooves 35A to 35E in FIGS. 1 to 6 that can be formed in the core piece 31m are shown in an enlarged manner for the purpose of clear illustration, and thus may not be true to scale. FIG. 2 shows one (on the front side) of several inner core members 310 by partially cutting away a middle resin mold portion 310m of the inner core member 310, with a part of an end surface 31e of the core piece 31m being exposed.

### Reactor

### Overall Configuration

The reactor 1 includes a coil 2 that is formed of a wire 2w that is spirally wound and a magnetic core 3 that is disposed within and outside the coil 2 and forms a closed magnetic path. The magnetic core 3 includes a plurality of columnar core pieces 31m and 32m, and a plurality of core pieces 31m are disposed within the coil 2. Each core piece 31m includes an end surface 31e disposed orthogonal to the axis direction of the coil 2 and a circumferential surface disposed parallel to the axis direction of the coil 2. When the coil 2 is energized, a magnetic flux flowing through the coil 2 passes orthogonally through the end surface 31e of the core piece 31m. A feature of the present invention lies in that a resin portion (in this example, a part of the middle resin mold portion 310m (FIG. 2)) is bonded to the end surface 31e of the core piece 31m, and the end surface 31e of the core piece 31m has an intersecting groove 35A having a specific shape. This will be described in further detail below.

### Coil

As shown in FIGS. 1 and 2, the coil 2 includes a pair of tubular wound portions 2a and 2b that are formed by spirally winding one continuous wire 2w and a connecting portion 2r that is formed from a part of the wire 2w and connects the wound portions 2a and 2b. The wound portions 2a and 2b are disposed in parallel (side by side) such that the axis directions of the wound portions 2a and 2b are parallel. In this example, the wire 2w is made of a coated flat wire (so-called enamel wire) including a flat wire conductor (for example, copper) and an insulating coating (for example, polyamide imide) covering the outer circumference of the conductor, and the wound portions 2a and 2b are made of an edgewise coil. Two ends 2e and 2e of the wire 2w extend from the wound portions 2a and 2b in an appropriate direction, and terminal fittings 8 and 8 are respectively connected to top conductor portions of the ends 2e and 2e. The coil 2 is electrically connected to an external apparatus (not shown) such as a power supply via the terminal fittings 8.

### Magnetic Core

The magnetic core 3 includes a portion disposed within the coil 2 (the wound portions 2a and 2b) and a portion that is substantially not disposed in the coil 2 and protrudes from the coil 2. The magnetic core 3 in this example includes, as the constituent elements, core members in which a portion constituting a magnetic path is covered with a resin, or to be specific, two inner core members 310 and 310 and two outer core members 320 and 320. As shown in FIG. 2, each inner core member 310 includes a middle body portion 31 that is part of the magnetic path and a middle resin mold portion 310m. Each outer core member 320 includes a side body portion 32 that is part of the magnetic path and 32 and a side resin mold portion 320m. In the magnetic core 3, the pair of outer core members 320 and 320 are combined so as to couple the pair of inner core members 310 and 310 disposed side by side, and thereby the middle body portion 31, 31 and the side body portion 32, 32 are disposed so as to form an annular shape, and form a closed magnetic path when the coil 2 is energized.

### Middle Body Portion

As shown in a dotted circle in FIG. 2, each middle body portion 31 has a columnar shape (in this example, a rectangular parallelepiped shape with round corners) in which a plurality of core pieces 31m, . . . made of a soft magnetic material and a plurality of gap members 31g made of a material having a smaller relative magnetic permeability than the core pieces 31m (for example, a non-magnetic material such as alumina) are alternately arranged.

In this example, each core piece 31m and each gap member 31g are bonded by an adhesive 370. A middle resin mold portion 310m is provided along the outer shape of the middle body portion 31 so as to cover the entire outer circumference. Apart of the resin mold portion 310m, or to be specific, a flat resin layer 372 covering each end surface of the middle body portion 31 (in this example, the end surface 31e of the core piece 31m) is disposed between a core piece 31m having the middle body portion 31 to which the resin layer 372 is bonded and a core piece 32m provided in the side body portion 32 that is adjacent to the core piece 31m, and functions as a gap. That is, the reactor 1 in this example includes a plurality of gaps (the gap member 31g and the resin layer 372) made of different materials. Also, it can be said that the end surface 31e of the core piece 31m is a gap-forming surface. The number of core pieces 31m and the number of gap members 31g can be changed as appropriate.

The adhesive 370 and the resin layer 372 constitute resin portions 37 bonded to the end surfaces 31e of the core piece 31m, the end surfaces 31e being orthogonal to the magnetic flux flowing through the coil 2.

### Side Body Portion

The side body portion 32 is a core piece 32m made of a soft magnetic material. The core piece 32m shown in this example has a dome shape (deformed trapezoidal shape) having a flat inner end surface 32e to which a pair of inner core members 310 and 310 are connected, and an upper surface and a lower surface that extend from the inner end surface 32e, the dome shape having a cross-sectional area that decreases from the inner end surface 32e toward the outside. The inner end surface 32e of the core piece 32m is also an end surface that is orthogonal to the magnetic flux flowing through the coil 2. A side resin mold portion 320m is formed along the outer shape of the side body portion 32, covering the outer circumference of the side body portion 32, except for a region of the inner end surface 32e, the region being where the inner core members 310 and 310 are connected.

### Material

In this example, the core pieces 31m and 32m are powder compacts made substantially of metal particles and an insulating material present between the metal particles. As the resin constituting the middle resin mold portion 310m and the side resin mold portion 320m, a polyphenylene sulfide (PPS) resin can be used. Other examples of the resin constituting the middle resin mold portion 310m and the side resin mold portion 320m include thermoplastic resins such as a polytetrafluoroethylene (PTFE) resin, a liquid crystal polymer (LCP), nylon 6, nylon 66, nylon 10T, nylon 9T, nylon 6T and a polybutylene terephthalate (PBT) resin.

A powder compact is obtained by forming raw powders into a compact, the raw powders typically composed of powders of a metal such as iron or an iron alloy (for example, Fe—Si alloy or Fe—Ni alloy) and optionally a binder (for example, resin) and a lubricant, and thereafter heating the compact for the purpose of, for example, removing the strain caused during formation of the compact. By using coated powders obtained by subjecting metal powers to an insulation treatment or mixed powders of metal powders and an insulating material as the raw powders, a powder compact in which the insulating material is present between the metal particles after formed into the compact is obtained. Typically, the powder compact is made of coated powders in which metal particles are coated with an insulating coating. When forming the powder compact, generally, a die having a through hole, and an upper punch and a lower punch that are inserted into the through hole and compress raw powders charged into a forming space that includes the inner circumferential surface of the die are used. The compressed surfaces of the powder compact formed by the upper punch and the lower punch are typically surfaces that have excellent electric insulation properties and in which the insulating material is present between the metal particles. By using the compressed surfaces as the surfaces of the core pieces 31m and 32m that are disposed orthogonal to the magnetic flux flowing through the coil 2, the reactor 1 can reduce eddy currents caused by the coil 2.

### Intersecting Groove

The end surfaces 31e and 31e of each of the core pieces 31m included in the middle body portion 31 disposed within the coil 2 have a plurality of intersecting grooves 35A. In each intersecting groove 35A, a plurality of grooves intersect without forming a loop. In this example, the intersecting grooves 35A have the same shape, namely, a plus (+) shape in which two linear grooves having the same length are orthogonal to each other. The angle of intersection of the grooves is not limited to orthogonal and can be changed as appropriate. The angle of intersection may be acute (obtuse). The description regarding the angle of intersection also applies to the intersecting grooves 35B to 35E, which will be described later.

A plurality of intersecting grooves 35A shown in FIGS. 1 and 2 are lined up with a predetermined interval between them and are formed uniformly over each end surface 31e of the core piece 31m. To be specific, between adjacent intersecting grooves 35A and 35A forming a row, an intersecting groove 35A forming another row located above or below the row is disposed. That is, the intersecting grooves 35A of a plurality of rows are arranged in a staggered configuration in the right-left direction. The arrangement of the plurality of intersecting grooves 35A can be changed as appropriate. For example, an intersecting groove 35A forming a row and an intersecting groove 35A forming another row located above or below the row may be aligned in the right-left direction. The intersecting grooves 35A may also be arranged in other configurations depending on the number of intersecting grooves 35A. The description regarding the arrangement of a plurality of intersecting grooves also applies to the intersecting grooves 35B to 35E, which will be described later.

### Shape of Intersecting Groove

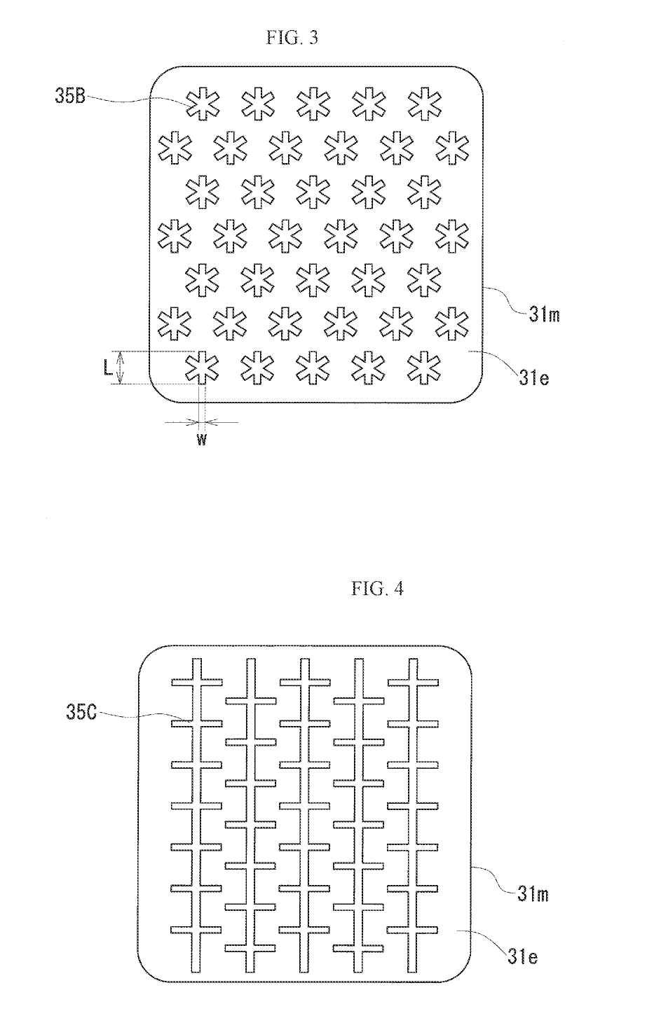

Other examples of the shape of the intersecting groove will be specifically described with reference to FIGS. 3 to 6.

An intersecting groove 35B shown in FIG. 3 is in the shape of an asterisk (*) in which three linear grooves having the same length intersect at an equal angle of intersection (at an angle of intersection of 60°). As described above, the number of grooves that form one intersecting groove may be set to three or more.

An intersecting groove 35C shown in FIG. 4 has a shape in which a plurality of linear grooves intersect with one linear groove. In the intersecting groove 35C, short grooves (of the same length) intersect with a relatively long groove (at an angle of intersection of 90°). In short, the intersecting groove 35C has a shape in which one of the grooves forming the intersecting grooves 35A is extended to form a continuously elongated groove. As described above, the number of grooves that form one intersecting groove may be increased, or the groove length may be varied. In this example, a plurality of intersecting grooves 35C are disposed vertically such that the long grooves are parallel to each other, with the lengthwise direction of the long grooves extending in the up-down direction, but may be disposed horizontally such that the long grooves are parallel to each other, with the lengthwise direction of the long grooves extending in the right-left direction.

An intersecting groove 35D shown in FIG. 5 has a shape in which a linear groove is continuous to form a spiral, and a plurality of linear grooves intersect with each of the segments that form the spiral (at an angle of intersection of 90°). The segments become shorter in length from the periphery of the end surface 31e of the core piece 31m toward the center. The plurality of grooves that intersect with each segment are short grooves having the same length. In short, the intersecting groove 35D has a shape obtained by changing the lengths of the long grooves of the intersecting grooves 35C as appropriate and disposing the grooves in a spiral configuration. As described above, the number of grooves that form one intersecting groove may be increased, the groove length may be varied, or a long continuous groove may be further provided. In this example, the intersecting groove 35D is in the shape of a rectangular spiral, but may be in the shape of a circular spiral.

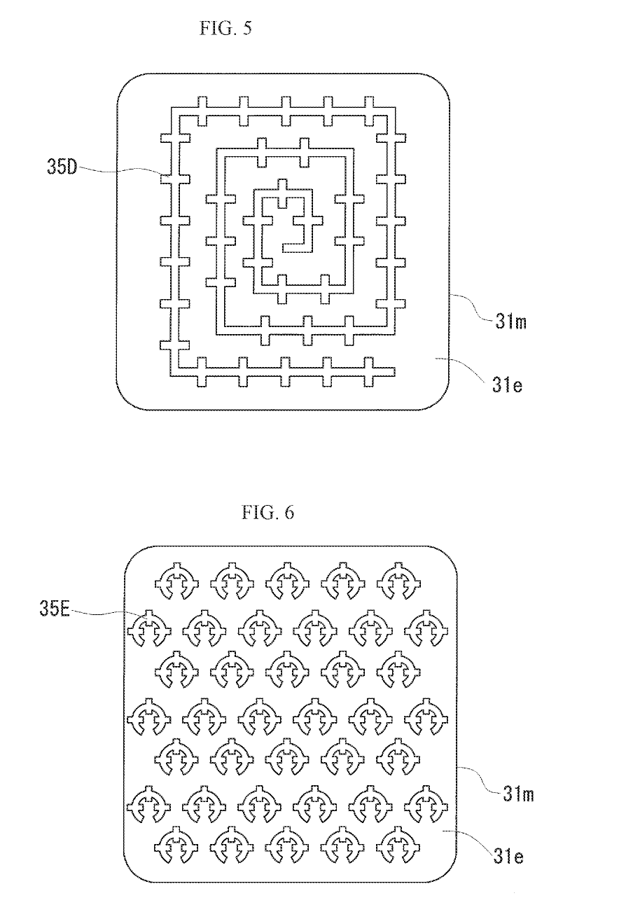

An intersecting groove 35E shown in FIG. 6 has a shape in which a plurality of linear grooves (in this example, short grooves of the same length) intersect with a groove having an inverted U (∩) shape (or a groove having a C shape) (at an angle of intersection of 90°). As described above, the number of grooves that form one intersecting groove may be increased, the groove length may be varied, a long continuous groove may be provided, or the intersecting groove may be formed so as to include grooves having different shapes such as a curved groove and a linear groove. In this example, three short grooves intersect with a groove having an inverted U (∩) shape at an equal interval, but the interval may be changed as appropriate.

The intersecting grooves 35A to 35E shown in FIGS. 1 to 6 that can be formed in the end surface 31e of the core piece 31m are merely examples. The intersecting groove may have various other shapes such as ≠, x, Ψ, and κ. Also, a plurality of intersecting grooves formed in one end surface 31e of the core piece 31m may have the same shape as shown in, for example, FIG. 1, or may have different shapes.

### Dimensions of Groove

The depth, width and length of each groove (first groove, second groove, . . . ) constituting one intersecting groove 35A and so on can be selected as appropriate. As shown in FIG. 3, groove width w refers to, when the end surface 31e of the core piece 31m is viewed in plan view, the length of a line section of a contour line that forms the outer shape of the groove, the line section forming a groove end, and groove length L refers to the length of a line section of the contour line, the line section forming an angle of intersection. As the depth of each groove becomes deeper, or as the groove width w or the groove length L becomes longer, the contact area of the end surface with the resin portion 37 increases, and it is therefore assumed that the bonding strength of the end surface to the resin portion 37 can be increased accordingly. However, if the depth is too deep, or the width w or the length L is too long, the magnetic components may be reduced, and the groove processing time may become longer, which reduces the productivity of the core piece 31m and leads to a reduction in the productivity of the reactor 1. From this perspective of view, each groove preferably has a depth of 10 μm or more and 200 μm or less, more preferably 30 μm or more and 150 μm or less. In this example, each groove has a depth of 50 μm or more and 120 μm or less. The groove width w and the groove length L may be selected according to the size of the end surface 31e of the core piece 31m, the groove shape or the like.

### Occupancy of Groove

The proportion of a total area of a plurality of intersecting grooves 35A in the area of one end surface 31e of the core piece 31m when the end surface 31e is viewed in plan view (hereinafter, referred to as “occupancy”) can be selected as appropriate. The bonding strength between the end surface 31e and the resin portion 37 is increased as the occupancy becomes higher, and thus the occupancy is preferably 10% or more, 15% or more, or more preferably 20% or more. In view of the magnetic characteristics and productivity described above, the occupancy is preferably 80% or less, 70% or less, or more preferably 50% or less.

In the example shown in FIGS. 1 and 2, the plurality of intersecting grooves 35A in one end surface 31e of the core piece 31m have equal dimensions (groove depth, width and length), but it is also possible to provide intersecting grooves having different dimensions. In this case, either of the following configurations is possible in which the intersecting grooves have the same shape but have different dimensions and in which the intersecting grooves have different shapes and have different dimensions.

### Method for Forming Intersecting Groove

The intersecting grooves 35A to 35E can be formed by using, for example, laser processing such as laser light irradiation. Irradiation conditions can be selected as appropriate such that the groove dimensions have the desired values. In this example, laser processing is used. Another method for forming grooves is, for example, cutting with a cutting tool. By forming grooves in one surface of a powder compact as described above by laser processing or the like, the insulating material present between metal particles may be removed. Accordingly, when grooves are formed in a compressed surface as described above, the groove portions may be electrically connected. However, with the specific intersecting groove 35A that does not have a loop, for example, the grooves forming the intersecting groove are interrupted without forming a loop, and thus eddy currents do not flow in a loop along the grooves. For this reason, by disposing the compressed surface as a surface of the core piece 31m, the surface being orthogonal to the magnetic flux flowing through the coil 2, and forming the intersecting groove 35A and so on in this surface (in this example, the end surface 31e), even when the magnetic flux flowing through the coil 2 passes through the end surface 31e upon energization of the coil 2, it is possible to prevent eddy currents from flowing in a loop along the intersecting groove 35A and so on.

### Method for Manufacturing Reactor

An example of a method for manufacturing the reactor 1 will be described by referring mainly to FIG. 2.

First, a plurality of intersecting grooves 35A are formed in each end surface 31e of the core pieces 31m. The end surfaces 31e of the core pieces 31m having the intersecting grooves 35A are bonded to gap members 31g by an adhesive 370, and thereby a middle body portion 31 is formed. In FIG. 2, sheet members are shown as the adhesive 370, but the adhesive 370 may be applied to one of the end surfaces 31e or the gap members 31g.

By using the prepared middle body portions 31 and 31 and separately produced side body portions 32 and 32 as cores, inner core members 310 and 310 and outer core members 320 and 320 are manufactured by injection molding such as insert molding. In the obtained inner core member 310, a part (resin layer 372) of the middle resin mold portion 310m is bonded to each of the end surfaces 31e and 31e of the core pieces 31m and 31m located at the ends of the middle body portion 31, and the adhesive 370 is bonded to each of the end surfaces 31e and 31e of the core piece 31m located in the middle of the middle body portion 31.

Then, the inner core members 310 and 310, a separately produced coil 2, and the outer core members 320 and 320 are combined so as to form an annular magnetic core 3, and at the same time, support the coil 2 by the magnetic core 3. The end surfaces 310e and 310e of the inner core members 310 and 310 and the inner end surfaces (the inner end surfaces 32e of the side body portions 32) of the outer core members 320 may be bonded by an adhesive (not shown) or the like. A reactor 1 is obtained through the steps described above.

### Advantageous Effects

As a result of the core piece 31m according to Embodiment 1 including a plurality of intersecting grooves 35A (35B, 35C, 35D, 35E or the like) having a specific shape formed in each end surface 31e of the core piece 31m, when a resin portion 37 is bonded to the end surface 31e, strong bonding can be achieved. Also, when the end surface 31e of the core piece 31m is disposed so as to be orthogonal to the magnetic flux flowing through the coil 2, the generation of eddy currents can be reduced. In the reactor 1 according to Embodiment 1, by using core pieces 31m in which a plurality of intersecting grooves 35A (35B, 35C, 35D, 35E or the like) having a specific shape are formed in each end surface 31e orthogonal to the magnetic flux flowing through the coil 2, as one of a plurality of core pieces 31m and 32m of the magnetic core 3, it is possible to achieve both strong bonding between the core pieces 31m and the resin portions 37 and reduction of the generation of eddy currents.

To be more specific, a high bonding strength between the core piece 31m and the resin portion 37 and excellent bondability are achieved for the following reasons: (1) the contact area between the end surface 31e of the core piece 31m and the resin portion 37 (in this example, the adhesive 370 and the resin layer 372) bonded to the end surface 31e is large due to the plurality of intersecting grooves 35A and so on; and (2) separation of the resin portion 37 along a groove forming one intersecting groove 35A and so on can be suppressed by another groove forming the intersecting groove 35A. In addition, because the intersecting grooves 35A and so on have a specific shape that does not form a loop, as described above, even when the magnetic flux flowing through the coil 2 passes through the end surface 31e of the core piece 31m, eddy currents are not easily generated.

In particular, in the reactor 1 according to Embodiment 1, because a plurality of intersecting grooves 35A and so on are formed in both end surfaces 31e and 31e of the core piece 31m and the resin portion 37 is thereby strongly bonded, unification of the middle body portion 31 is sufficiently increased, and it is expected that vibrations and noise will be readily reduced when in use.

### Variation 1-1

In Embodiment 1, a configuration was described in which the intersecting grooves 35A and so on are formed in both end surfaces 31e and 31e of the core piece 31m. If no resin portion 37 is bonded to one end surface 31e of the core pieces 31m, the intersecting grooves 35A and so on may be formed only in the other end surface 31e.

### Variation 1-2

In Embodiment 1, a configuration was described in which all of the core pieces 31m, . . . included in the middle body portion 31 have the intersecting grooves 35A and so on. A configuration is also possible in which at least one of the plurality of core pieces 31m, . . . included in the middle body portion 31 does not have the intersecting grooves 35A and so on. In this case, for example, by disposing core pieces 31m and 31m having the intersecting grooves 35A and so on on opposite sides of a core piece that does not have the intersecting grooves 35A and so on so as to sandwich that core piece, the core pieces 31m and 31m having the intersecting grooves 35A and so on can rigidly hold the resin portions 37. Accordingly, it is expected that the unitarity of the plurality of core pieces 31m, . . . can be increased to some extent.

### Variation 1-3

In Embodiment 1, a configuration was described in which the resin portions 37 are constituted by the adhesive 370 and a part (resin layer 372) of the middle resin mold portion 310m. A configuration is also possible in which the resin portions are constituted by a part of the resin mold portion 310m while omitting the gap members 31g and the adhesive 370. That is, all of the gaps between core pieces 31m and 31m and the gaps between core pieces 31m and 32m can be constituted by a part of the resin mold portion 310m. In this case, for example, resin gaps can be easily formed by, at the time when the resin mold portion 310m is formed, arranging core pieces 31m having intersecting grooves 35A and so on at a regular interval in a mold and then charging a resin so as to fill the space between adjacent core pieces 31m and 31m. In this case, it is preferable that both end surfaces 31e and 31e of the core pieces 31m have intersecting grooves 35A and so on because the resin portion between the core pieces 31m and 31m can be strongly bonded. Also, in this case, the resin portion between the core pieces 31m and 31m also functions as an adhesive (bonding material) for bonding the core pieces 31m and 31m, in addition to the function as a gap described above. Because the core pieces 31m and 31m are strongly bonded by the resin mold portion 310m, unification of the middle body portion 31 is sufficiently increased, and it is expected that vibrations and noise will be readily reduced when the reactor is in use.

### Variation 1-4

In Embodiment 1, a configuration was described in which the intersecting grooves 35A and so on are formed only in the core piece(s) 31m disposed within the coil 2. It is also possible to form the intersecting grooves 35A and so on in a core piece 32m that is not disposed in the coil 2. In this case, the intersecting grooves 35A and so on may be formed in the inner end surface 32e of the core piece 32m. As described above, by using an adhesive to bond the inner end surface 32e and the end surface 310e of the inner core member 310, the adhesive becomes a part of the resin portion bonded to the inner end surface 32e of the core piece 32m that is orthogonal to the magnetic flux flowing through the coil 2.

Alternatively, the covering region of the side resin mold portion 320m may be changed such that the entire outer circumference of the core piece 32m including the inner end surface 32e is covered by the resin mold portion 320m. In this case, a flat resin layer that is a part of the resin mold portion 320m and covers the inner end surface 32e of the core piece 32m serves as the resin portion bonded to the inner end surface 32e orthogonal to the magnetic flux flowing through the coil 2.

According to the configuration of Variation 1-4, both the core pieces 31m and 32m of the magnetic core 3 have resin portions on their end surfaces (31e, 32e) orthogonal to the magnetic flux flowing through the coil 2.

### Variation 1-5

In Embodiment 1, a configuration was described in which the middle body portion 31 in which a plurality of core pieces 31m and a plurality of gap members 31g are alternately arranged is unitarily covered with the middle resin mold portion 310m. Other than this configuration, a configuration is also possible in which a plurality of coated core pieces are formed, each coated core piece being obtained by forming a resin mold portion on a core piece 31m.

In each coated core piece, the intersecting grooves 35A and so on are formed in both end surfaces 31e and 31e of the core piece 31m, and a part (flat resin layer) of the resin mold portion is bonded. When such coated core pieces are combined, a part of the resin mold portion bonded to one end surface 31e of the core pieces 31m of adjacent coated core pieces, or in other words, two resin layers are disposed between the adjacent coated core pieces and form one gap. Accordingly, with this configuration, the gap members 31g can be omitted, and thus the number of components can be reduced.

### Variation 1-6

In Embodiment 1, a configuration was described in which the magnetic core 3 includes four core members (the inner core members 310 and 310 and the outer core members 320 and 320). Other than this configuration, for example, the following configurations are also possible: namely, in a configuration in which the magnetic core 3 includes a pair of L-shaped core members, each being formed by combining one middle body portion 31 and one side body portion 32 so as to form an L shape, which is unitarily held by a resin mold portion; and in a configuration in which the magnetic core 3 includes a U-shaped core member and an outer core member, the U-shaped core member being formed by combining two middle body portions 31 and 31 and one side body portion 32 so as to form a U shape, which is unitarily held by a resin mold portion.

### Other Configurations

The reactor 1 shown in FIG. 1 may include an engagement portion constituted by the middle resin mold portion 310m and the side resin mold portion 320m, an attachment portion 325 and a partition portion described below. At least one of the engagement portion, the attachment portion 325 and the partition portion may be omitted.

### Engagement Portion between Inner Core Member 310 and Outer Core Member 320

In this example, the middle resin mold portion 310m has, in the portion covering the circumferential surface of the middle body portion 31, a thin region near the end surface 310e. The side resin mold portion 320m includes two tubular portions protruding from the inner end surface of the outer core member 320. The thin region and the tubular portions function as the engagement portion.

### Attachment Portion 325 for Attaching Reactor 1 to Installation Object (FIGS. 1 and 2)

In this example, the side resin mold portion 320m has an outwardly protruding protrusion piece. A bolt hole 325h is formed in the protrusion piece, and the protrusion piece is used as the attachment portion 325.

### Partition Portion between Wound Portions 2a and 2b

In this example, the side resin mold portion 320m includes a plate piece that protrudes from the inner end surface of the outer core member 320 and is provided between the two tubular portions. The plate piece functions as the partition portion, and ensure insulation between the wound portions 2a and 2b.

Other than the above, the reactors according to Embodiment 1 and Variations may include the following members. It is also possible to omit at least one of these members.

### Sensor

A sensor (not shown) for measuring the physical quantity of the reactor 1 may be provided such as a temperature sensor, a current sensor, a voltage sensor or a magnetic flux sensor.

### Heat Dissipation Plate

A heat dissipation plate (not shown) may be provided at any position in the outer circumferential surface of the coil 2. For example, by providing a heat dissipation plate on the installation surface (in this example, lower surface) of the coil 2, heat from the coil 2 can be effectively transferred to an installation object such as a converter case via the heat dissipation plate, and heat dissipation properties can be enhanced. As the material for constituting the heat dissipation plate, a material having excellent thermal conductivity can be used, including a metal such as aluminum or an alloy thereof, and a non-metal such as alumina. The heat dissipation plate may be provided on the entire installation surface (in this example, lower surface) of the reactor 1. The heat dissipation plate can be fixed to, for example, an assembly obtained by combining the coil 2 and the magnetic core 3 by a bonding layer described below.

### Bonding Layer

In the installation surface (in this example, lower surface) of the reactor 1, a bonding layer (not shown) may be provided on at least the installation surface (in this example, lower surface) of the coil 2. As a result of the bonding layer being provided, the coil 2 can be rigidly fixed to an installation object or the above-described heat dissipation plate in the case where the heat dissipation plate is provided, and it is therefore possible to limit the motion of the coil 2, improve heat dissipation properties, stabilize fixation to the installation object or the heat dissipation plate, and the like. As the material for constituting the bonding layer, it is preferable to use a material having excellent heat dissipation properties (for example, having a thermal conductivity of 0.1 W/m K or more, more preferably 1 W/m K or more, and even more preferably 2 W/m K or more) and including an insulating resin, in particular, a ceramic filler or the like. Specific examples of the resin include thermosetting resins such as an epoxy resin, a silicone resin and an unsaturated polyester and thermoplastic resins such as a PPS resin and an LCP.

The present invention is not limited to these examples. The scope of the present invention is indicated by the appended claims, and all changes that come within the meaning and range of equivalency of the claims are to be embraced within the scope. For example, it is possible to provide a reactor including a coil having only one wound portion. For example, the core piece including specific intersecting grooves described above can be used as a constituent element of a magnetic core of a magnetic component other than the reactor.

### Industrial Applicability

The core piece according to the present invention is suitable for use as a constituent element of a magnetic component such as a reactor, a transformer, a motor or a choking coil. The reactor according to the present invention is suitable for use in an on-board converter (typically a DC-DC converter) mounted on a vehicle such as a hybrid vehicle, a plug-in hybrid vehicle, an electric vehicle or a fuel cell vehicle, a converter of an air conditioner, and a component of a power conversion apparatus.

1. A core piece that constitutes a magnetic core disposed within or outside a coil formed of a wound wire,
the core piece comprising an end surface that is orthogonal to a magnetic flux flowing through the coil and to which a resin portion is bonded,
wherein the end surface has an intersecting groove in which a plurality of grooves intersect without forming a loop.

2. The core piece according to claim 1, wherein the core piece is a powder compact comprising metal particles and an insulating material present between the metal particles.

3. The core piece according to claim 1, wherein the core piece constitutes a portion of the magnetic core, the portion being disposed within the coil.

4. A reactor comprising:
a coil formed of a wound wire;
a magnetic core including a plurality of core pieces comprising the core piece according to claim 1; and
a resin portion that is bonded to the end surface of the core piece having the intersecting groove.

5. The reactor according to claim 4, wherein the resin portion bonded to the end surface is disposed between core pieces that are adjacent to each other, forming a gap.

6. The reactor according to claim 4, comprising a resin mold portion that covers an outer circumference of at least one of the plurality of core pieces,
wherein the resin portion bonded to the end surface is a part of the resin mold portion.

7. The core piece according to claim 2, wherein the core piece constitutes a portion of the magnetic core, the portion being disposed within the coil.

8. The reactor according to claim 5, comprising a resin mold portion that covers an outer circumference of at least one of the plurality of core pieces,
wherein the resin portion bonded to the end surface is a part of the resin mold portion.
